(19) United States
(12) Patent Application Publication
(10) Pub. No.: US 2026/0172561 A1
(43) Pub. Date: Jun. 18, 2026

(54) OBJECT-BASED QP ADAPTATION

(71) Applicant: Telefonaktiebolaget LM Ericsson (publ), Stockholm (SE)

(72) Inventors: Christopher HOLLMANN, Uppsala (SE); Rickard SJÖBERG, Stockholm (SE); Jacob STRÖM, Stockholm (SE)

(73) Assignee: Telefonaktiebolaget LM Ericsson (publ), Stockholm (SE)

(21) Appl. No.: 19/117,363

(22) PCT Filed: Jul. 6, 2023
(86) PCT No.: PCT/SE2023/050712

§ 371 Date: Mar. 31, 2025

Related U.S. Application Data
(60) Provisional application No. 63/414,211, filed on Oct. 7, 2022.

(51) Int. Cl. H04N 19/124; H04N 19/167; H04N 19/172; H04N 19/176; H04N 19/20; H04N 19/463

(52) U.S. Cl. CPC H04N 19/124; H04N 19/167; H04N 19/172; H04N 19/176; H04N 19/20; H04N 19/463

(57) ABSTRACT

A method for encoding a picture in which at least a first object has been detected, wherein the picture comprises a first block. The method comprises obtaining first bounding information indicating the spatial location of the first object within the picture, wherein the bounding information specifies a first picture area within which the first object is located. The method also includes determining a first quantization parameter, QP, value for the first block, wherein determining the first QP value for the first block comprises using the first bounding information in a process for determining the first QP value. The process for determining the first QP value comprises: determining a size value indicating a size of the first picture area and comparing the determined size value to a size threshold; and/or determining a first overlap value specifying the amount of the first picture area that is included within the first block and comparing the first overlap value to a first overlap threshold; and quantizing data associated with the first block using the determined first QP value.

### TECHNICAL FIELD

Disclosed are embodiments related to picture encoding.

### BACKGROUND

### Versatile Video Coding (VVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original sample data and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### Components

A video sequence consists of a series of pictures where each picture consists of one or more components. A picture in a video sequence is sometimes denoted ‘image’ or ‘frame’. Each component in a picture can be described as a two-dimensional rectangular array of sample values (or “samples” for short). It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### Coding Units and Coding Blocks

In many video coding standards, such as HEVC and VVC, each component of a picture is split into blocks and the coded video bitstream consists of a series of coded blocks. A block is a two-dimensional array of samples. It is common in video coding that the picture is split into units that cover a specific area of the picture.

Each unit consists of all blocks from all components that make up that specific area and each block belongs fully to one unit. The macroblock in H.264 and the Coding unit (CU) in HEVC and VVC are examples of units. In VVC the CUs may be split recursively to smaller CUs. The CU at the top level is referred to as the coding tree unit (CTU).

A CU usually contains three coding blocks, i.e. one coding block for luma and two coding blocks for chroma. The size of luma coding block is the same as the CU. The maximum CU size (maxCUwidth) is signaled in a parameter set. In the current VVC (i.e. version 1), the CUs can have size of 4×4 up to 128×128.

### Video Coding for Machines

As more and more video is being produced, the target audience of these videos has changed. Previously video was primarily consumed by humans, with the consequence that both compression standards and encoders were optimized to the human visual system. Nowadays the focus shifts more and more towards machines or algorithms analyzing video content. With machines evaluating the content that is produced by other machines, humans are no longer in the loop, i.e., there is no need to optimize standards or encoders towards preserving the optimal quality for humans. Therefore, if the encoder knows that the produced video stream will be primarily used by other machines, it can optimize the encoding towards features that are more important to machines.

One common way to approach encoding videos for machine vision purposes is the “analyze-then-compress” paradigm. In the “analyze-then-compress” paradigm, a video is first analyzed, and then the information obtained from this analysis is used to guide the encoding of the video.

Generally, pictures of the video sequence are fed into an analyzer, which can, for example, implement an object detection algorithm. This algorithm produces guiding information, which can, for example, include a list of objects, enumerating objects in each picture, and also include, for each object, location information indicating where in each picture the object is located. The same pictures are entered into the encoder which also takes the guiding information as input.

### Adaptive QP

One example of optimizing the compression process is using an adaptive quantization parameter (QP). Each picture in a video sequence is encoded using a QP, the value of which determines the granularity of the quantization process, and, therefore, has a significant impact on the quality of the reconstructed video. This QP value is also referred to as the picture QP. Simplified, it can be said that a low picture QP corresponds to high visual quality and results in a high bitrate video stream, and using a high picture QP results in low visual quality and low bitrate. The visual difference between quantization steps is not linear. Increasing the picture QP from 20 to 25 is in many cases hardly visible, whereas increasing the picture QP from 45 to 50 is a clear visual degradation.

Most modern video compression standards such as HEVC or VVC contain a mechanism to encode a delta QP. This mode allows encoding blocks with a QP offset, resulting in some parts of the picture being encoded with higher or lower quality than other parts. This can be beneficial to both humans and machines, depending on the algorithm used to determine the QP offset.

The QP offset may be applied to the picture QP. For example, assume that the picture QP for a picture is set equal to 30. If one block is assigned by an algorithm to have a QP offset equal to −5, then the QP value that this block will be encoded at is equal to 25. If the next block is assigned to a QP offset of +5, then that block will be encoded using a QP value of 35.

The QP offset can be any integer value. Each codec uses a different allowed QP range, for example HEVC uses 0-51 and VVC 0-63. Other codecs may use different ranges. As noted above, codecs such as HEVC or VVC are block-based, meaning they divide each picture into CTUs and these CTU blocks can then be split into CUs to allow for a more detailed compression.

### Machine Vision Tasks

There are many different machine vision tasks that algorithms can perform. The selection of which task is used in a given situation is based on the use case to which the algorithm is applied. An example of a common task is object detection, where the algorithm tries to find objects and their position in the current picture. These objects are then marked with a bounding box, which consists of several descriptive parameters including:
i) a position, usually the top left corner of the object. In some cases, the middle of the object is given;
ii) the width and height of the object or a second position, which usually indicates the bottom right corner of the object;
iii) a label indicating to which class the object belongs; and
iv) a score indicating how certain the algorithm is that at the given position an object of the determined class can be found (this score is sometimes kept internally in the algorithm).

Another task often used is instance segmentation, which is similar to object detection but instead of only finding a bounding box that describes the object, an exact determination of which pixels belong to the object is made. A third common task is object tracking, where objects are detected and traced through different pictures of a video sequence. Here objects are assigned a unique identifier and a key part of the task is to assign the same identifier to objects that appear in multiple pictures.

### Overlap Calculation

An overlap between an object and a CTU can be calculated by dividing the area of the bounding box that covers part of the CTU by the total area of the CTU.

The area of the bounding box that covers part of a CTU can be determined with the following method:

$$area = ( min ( {x}_{Or} , {x}_{Cr} ) - max ( {x}_{Ol} , {x}_{Cl} ) ) * ( min ( {y}_{Ob} , {y}_{Cb} ) - max ( {y}_{Ot} , {y}_{Ct} ) )$$

where x_{Or} is the right x-value of the bounding box, x_{Cr} is the right x-value of the CTU, x_{Ol} is the left x-value of the bounding box, xc is the left x-value of the CTU, y_{Ob} is the bottom y-value of the bounding box, y_{Cb} is the bottom y-value of the CTU, y_{Ot} is the top y-value of the bounding box, and y_{Ct} is the top y-value of the CTU.

The overlap may also be calculated using pixel allocation. The number of pixels of the object that fall inside the boundary of the corresponding CTU need to be counted and divided by the total number of pixels in the CTU.

### Look-Up Tables

One commonly used mechanism to handle calculations in compression technologies is a look-up table. A look-up table maps all possible values that can be entered in a calculation to the result of the calculation, thus removing the need to calculate any values. When a calculation is performed very often, replacing the mathematical operations with a look-up table can save time and increase the performance. This, however, comes at the cost of increased memory requirements. For example, if there is a large number of possible input values, the table might need too much memory.

There are ways of combining computation and look-up tables. For example, a binary shift (corresponding to a division by 2 with rounding down) can reduce the number of input values by half. This would result in two input values being mapped by the look-up table to the same output value.

### SUMMARY

Certain challenges presently exist. For instance, existing QP algorithms are inefficient for encoding video for machine vision tasks.

Accordingly, in one aspect there is provided a method for encoding a picture in which at least a first object has been detected, wherein the picture comprises a first block. The method includes obtaining first bounding information indicating the spatial location of the first object within the picture, wherein the bounding information specifies a first picture area (e.g., a rectangular picture area) within which the first object is located. The method also includes determining a first quantization parameter (QP) value for the first block, wherein determining the first QP value for the first block comprises using the first bounding information in a process for determining the first QP value. The process for determining the first QP value comprises: determining a size value indicating a size (relative size or absolute size) of the first picture area and comparing the determined size value to a size threshold; and/or determining a first overlap value specifying the amount of the first picture area that is included within the first block and comparing the first overlap value to a first overlap threshold; and quantizing data associated with the first block (e.g., transformed residuals for the first block) using the determined first QP value.

In some aspects, there is provided a computer program comprising instructions which when executed by processing circuitry of an encoding apparatus causes the encoding apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an encoding apparatus that is configured to perform the methods disclosed herein. The encoding apparatus may include memory and processing circuitry coupled to the memory.

An advantage of embodiments disclosed herein allows for the efficient encoding of pictures for machine vision purposes, for example, by allowing the same performance at a lower bit rate. Network costs and delays can be reduced when less data is required.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 illustrates a picture with at least one object according to an embodiment.

FIG. 5 illustrates a picture with at least one object according to another embodiment.

FIG. 6 illustrates a graph showing three examples of functions according to an embodiment

FIG. 7 is a flowchart illustrating a process according to an embodiment.

FIG. 8 is a block diagram of an encoding apparatus according to an embodiment.

### DETAILED DESCRIPTION

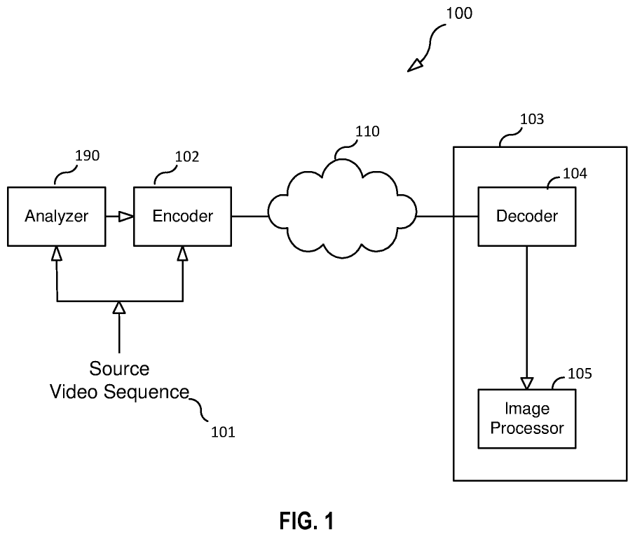

FIG. 1 illustrates a system 100 according to an embodiment. System 100 includes an encoder 102, an analyzer 190, and a decoder 104, wherein encoder 102 is in communication with decoder 104 via a network 110 (e.g., the Internet or other network). Encoder 102 encodes a source video sequence 101 into a bitstream comprising an encoded video sequence and transmits the bitstream to decoder 104 via network 108. In some embodiments, encoder 102 is not in communication with decoder 104, and, in such a scenario, rather than transmitting bitstream to decoder 104, the bitstream is stored in a data storage unit. Decoder 104 decodes the pictures included in the encoded video sequence to produce video data for image processing and/or display. Accordingly, decoder 104 may be part of a device 103 having an image processor 105. The image processor 105 performs machine vision tasks on the decoded pictures. One such machine vision task may be identifying the objects in the picture. The device 103 may be a mobile device, a set-top device, a head-mounted display, or any other device.

Additionally, as shown in FIG. 1, analyzer 190 is in communication with the encoder 102. Analyzer 190 functions to detect objects in the pictures of the source video sequence 101. Accordingly, in one embodiment, for at least one picture in the video sequence (e.g., for some or all of the pictures of the video sequence), analyzer 190 provides to the encoder 102 information regarding the objects detected in the picture (e.g., for each detected object, bounding information that specifies an area of the picture in which the objects exist). The encoder may then use the information from analyzer to determine a QP offset for each block of the picture and then uses the QP offsets in a process for encoding the picture. In another embodiments, analyzer 190 not only detects the objects in a picture, but also determines the QP offsets for one or more blocks of the picture and provides the QP offsets to the encoder.

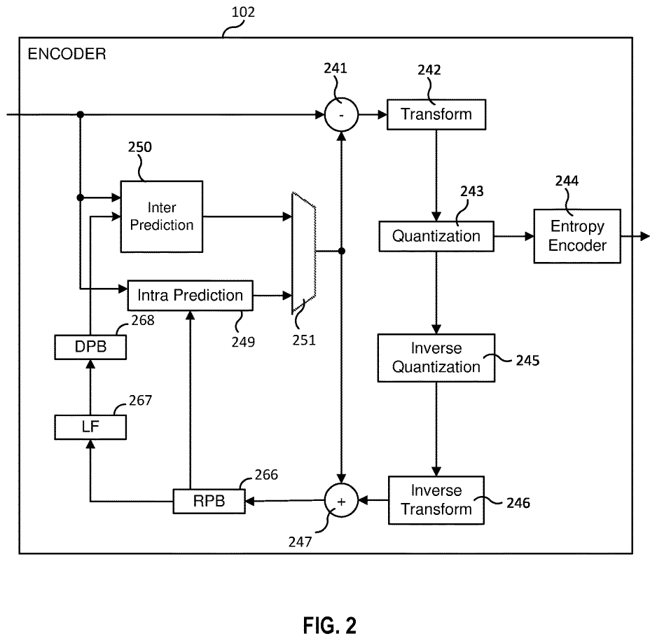

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a QP value (e.g., a QP value obtained based on a picture QP value for the picture in which the block is a part and block specific QP offset value), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF).

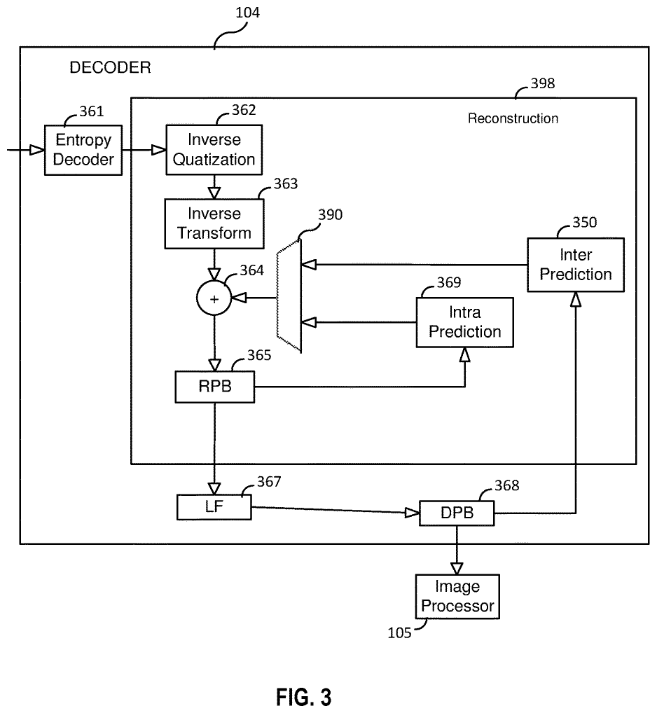

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to image processor 105. Pictures are stored in the DPB for two primary reasons: 1) to wait for picture output and 2) to be used for reference when decoding future pictures.

As described above, a challenge presently exists because existing picture encoding systems are not optimized for machines or algorithms analyzing video content. This disclosure overcomes this challenge by optimizing the encoder for machine vision tasks. For example, this disclosure considers an object's size and the overlap between a block and the bounding of an object when determining a QP value for use in encoding the block (i.e., for use in quantizing the transform coefficients corresponding to the block).

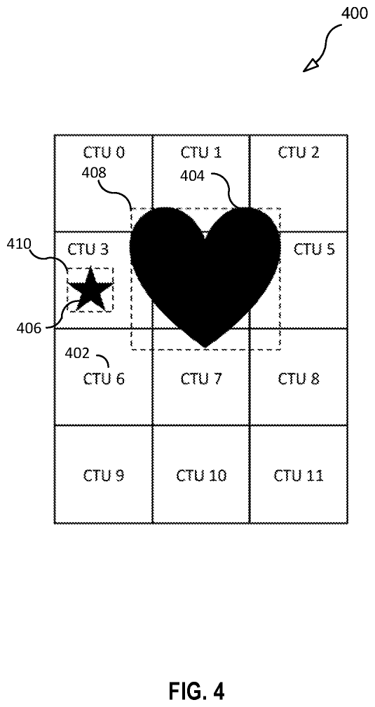

FIG. 4 illustrates a picture 400 of source video sequence 101. In this example, picture 400 includes twelve CTUs (labeled CTU 0 to CTU 11) and two objects: a heart 404 and a star 406. In other embodiments, the picture 400 may include any number of CTUs or blocks of varying size and shape. As shown in FIG. 4, heart 404 is located within bounding area 408 (a.k.a., heart bounding 408), which in this example is a bounding box, and star 406 is located within bounding area 410 (a.k.a., star bounding 410), also in the shape of a rectangle. In another embodiment, the bounding areas may be circular or any other shape and may be coextensive with the object that the bounding contains. In this example, an overlap between the heart 404 and CTU 6 exists if heart bounding 408 is used to determine the overlap. In this example, however, there is no actual overlap between the heart 404 and CTU 6.

Existing algorithms that assign QP values solely based on whether there is an overlap with the heart bounding 408 may be inefficient. As such, this disclosure overcomes the inefficiency, in part, by using an overlap threshold T_{LO} to evaluate whether a block (e.g., CTU 402) has significant overlap with an object.

In some embodiments, the threshold T_{LO} may be in the range of 5-30%, i.e., 5-30% of the CTU must be covered by the object's bounding. For example, using an T_{LO}=25%, the following differentiation could be made:
i) overlap=30%→greater than T_{LO}→QP offset=−1;
ii) overlap=20%→not greater than T_{LO} but greater than 0%→QP offset=+2; and
iii) overlap=0%→CTU and object don't overlap→QP offset=+6.

In other embodiments, an additional check may be performed to see how much area of an object's bounding is within the block. If a large CTU size is used and a small object is found, the first overlap might be less than T_{LO} even though the entire object is inside the CTU. In this embodiment, a separate threshold T_{OB} can be used to determine if the object is covered by the CTU. For example, if T_{OB} is set to 30% and an object's bounding is completely inside a single CTU, the CTU will always be treated as if there was significant overlap since 100% of the object is inside the CTU and 100%>T_{OB}=30%. The CTU will then be treated as if there was significant overlap regardless of how much area of the CTU is covered by the object. In this example, the star's bounding 410 in FIG. 4 is completely positioned in CTU 3, so regardless of the value of T_{LO}, CTU 3 will always be classified as a CTU with significant overlap.

In one embodiment, if the overlap between the object and a CTU is below the threshold T_{LO}, the CTU is treated as if there was no overlap at all. As an example, CTUs with significant overlap can be assigned a QP offset of 0 and CTUs without or with minor overlap a QP offset of +4.

In a different embodiment, a CTU with minor overlap may be treated separately and assigned a QP offset that is neither the offset for CTUs with an object nor the offset for CTUs without objects. As an example, the QP offset for CTUs with significant overlap can be set to 0, for CTUs without objects to +4, and for CTUs with minor overlap to +2.

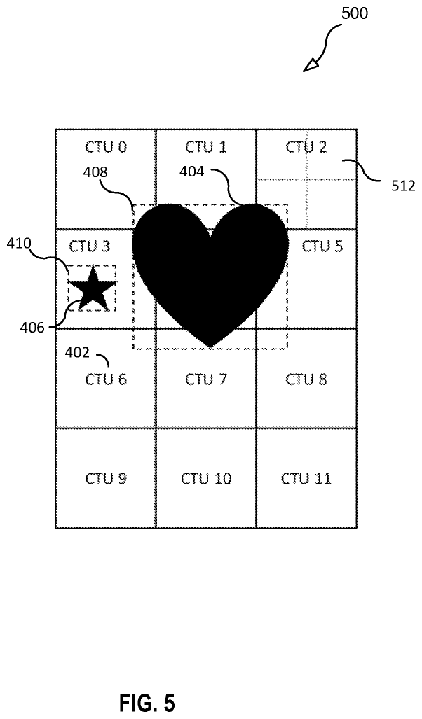

In FIG. 4, each of the CTUs may be further divided into smaller blocks. Many standards, including HEVC and VVC, allow changing QP offsets in a more fine-grained way. In some embodiments, a CTU may be split into four CUs in a quad split fashion (see, e.g., CTU 2 shown in FIG. 5), it is possible to have a lower QP offset in, say, the lower left CU and a higher QP offset in the remaining three CUs.

In FIG. 5, CTU 2 of picture 500 is split into four CUs, and the bottom left CU is given a lower QP value than the remaining three CUs in CTU 2, because it contains a part of heart bounding 408 while the other CUs do not. Having more fine-grained control over the QP can save bits by reducing the number of bits in regions outside objects (the three remaining CUs in FIG. 5, for instance). In this embodiment, however, the QP changes must now be signaled several times within the CTU instead of just once increasing the number of bits. Therefore, in this embodiment, more fine-grained control is exercised at low QPs, where QP offset signaling is relatively inexpensive, and less fine-grained control is exercised at high QPs, where QP offset signaling would make up a larger proportion of the total number of bits.

### Large Objects

Generally, machine vision algorithms have, similar to humans, an easier time recognizing large objects compared to small objects. If the picture or video is compressed, a larger object will cover a larger proportion of the picture and therefore, on average, be described by a larger proportion of the bits. Thus, larger objects are described with more bits than smaller objects, which puts small objects at a disadvantage when it comes to recognition performance. Another way to view this is that large objects are described with bits unnecessarily, and that recognition could be carried out if fewer bits were used to represent them. This disclosure counteracts this phenomenon by treating large objects differently from small objects.

In some embodiments, the size of an object is compared to a threshold T_{S}. T_{S} may be either a relative threshold indicating that the object covers at least X % of the picture, or an absolute threshold indicating that the object covers at least Y pixels. In the second case, the threshold is independent of the total size of the picture. Objects which are not large may be referred to as small objects. If a CTU has an overlap with a large object, it is treated as a “large object CTU”. “Large object CTUs” may be assigned a different QP value than other CTUs that have an overlap, and a different QP value than other CTUs that do not have any overlap with objects. If a CTU has an overlap with two or more different objects, it should be treated as a “large object CTU” only if all objects that have an overlap with the CTU are large objects. If there is an overlap with at least one small object, the CTU is treated as a normal CTU that has an overlap with at least one non-large object.

In one embodiment, the relative threshold T_{S} is set to 30%. For CTUs that have no objects, i.e., no overlap with any object bounding, the QP offset is set to a first value (e.g. +4). For CTUs that only overlap with large objects, the QP offset is set to a second value (e.g., +2). For CTUs that have an overlap with at least one small object, the QP offset is set to a third value (e.g., 0). As an example, if a picture has only one object and where that object covers 35% of the picture, all CTUs that have an overlap with the object will be coded with a QP offset of +2 and all other CTUs with a QP offset of +4.

In another embodiment, the absolute threshold T_{S} is set to 150,000 pixels, corresponding to a size of 300×500 pixels. For CTUs that have no overlap with any objects, the QP offset is set to the first value. For CTUs that have only overlap with large objects, the QP offset is set to the second value. For CTUs that have an overlap with at least one small object, the QP offset is set to a third value. As an example, if a picture has one object of 400×400 pixels (160,000 in total), all CTUs that have an overlap with the object will be coded with a QP offset of +2 and all other CTUs with a QP offset of +4 or a third value.

In FIG. 4, for example, the heart 404 may be considered a large object and the star 406 a small object, and the evaluation is done using the heart bounding 408 and star bounding 410. In this embodiment, CTUs 0-2 and 4-8 will be encoded using a QP offset of +2 as there is only overlap with a large object, CTU 3 will be encoded using a QP offset 0 as there is overlap with a small object, and CTUs 9-11 will be encoded using a QP offset +4 as there is no overlap with any of the objects.

In the above embodiment, CTUs have been used as the unit at which QPs can be changed. In other embodiments, it is possible to perform more fine-grained calculations, such as, performing the calculations at the CU level.

In some embodiments, the use of an additional second threshold allows classification of objects into large, medium and small. This second threshold may be a relative or an absolute thresholds.

### Dynamic Offset

In some embodiments, it may be beneficial to dynamically calculate the QP offset. As described earlier, the QP value (or “QP” for short) can be used as a proxy for quality. The visual degradation of a reconstructed video is not linear, in other words, increasing the QP by a specific step when the base QP is low gives less visual degradation than increasing the QP by the same step when starting at a high QP.

This can be used by designing a mechanism to dynamically determine the QP offset for each block. This can, for example, be a linear function of the format:

$${QP}_{offset} = m * {QP}_{picture} + n ,$$

where, for each block, the parameters m and n are chosen based on the objects that overlap the block, as described below.

The resulting offset may additionally be clipped to a specified range:

$${QP}_{clip \_ offset} = Clip ( max , min , {QP}_{offset} ) ,$$

where the parameters max and min are chosen based on objects that overlap the block, as described below.

The clipping operation adjusts the QP offset so that if the offset exceeds the max value, the max value is used and, correspondingly, if the offset is less than the min value, the min value is used. Otherwise, the QP offset value is not modified.

This mechanism may be used with any of the embodiments described in this application. In some embodiments, the following functions may be applied when comparing the overlap between a block and the bounding of an object to T_{LO} as discussed above:
i) overlap>T_{LO}→function A (e.g., a first set of specific values for m, n, min, and max);
ii) overlap<=T_{LO} and overlap>0%→function B (e.g., a second set of specific values for m, n, min, and max); and
iii) overlap=0%→function C (e.g., a third set of specific values for m, n, min, and max).

This will result in the QP offset varying based on the picture QP. In other embodiments, the same function may be used for at least two overlap areas, for example:
i) overlap>T_{LO}→function A;
ii) overlap<=T_{LO} and overlap>0%→function A; and
iii) overlap=0%→function C.

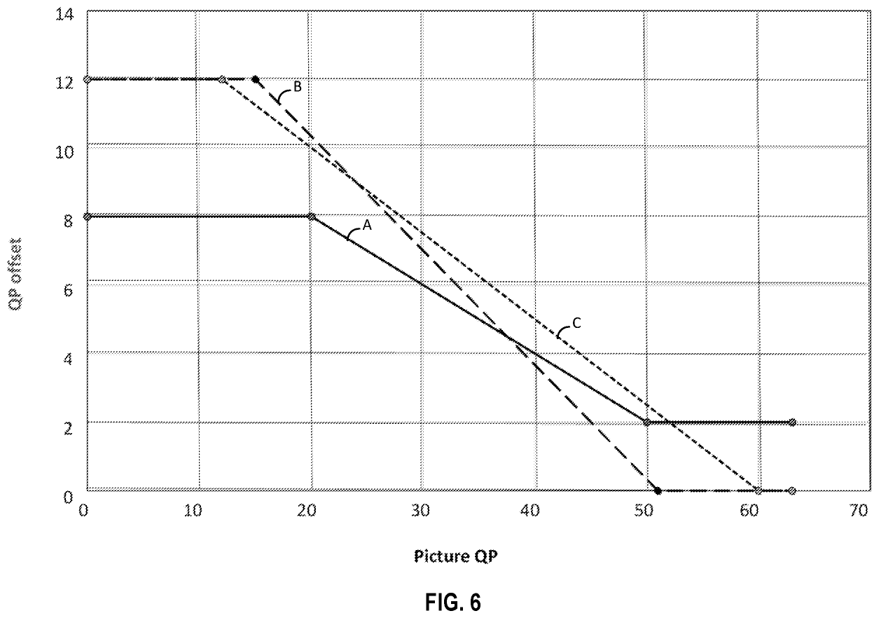

FIG. 6 illustrates a graph 600 showing an example of each one of the three functions (A, B, and C) that can be used to dynamically determine the QP offsets using a QP picture range from 0 to 63. The parameters m and n as well as the clipping values for the example functions are listed in Table 1 below. These functions only serve as examples.

TABLE 1
Parameter values for functions A, B, and C

| | m | n | min | max |
|---|---|---|---|---|
| Function | −1/5 | 12 | 2 | 8 |
| A | | | | |
| Function | −1/3 | 17 | 0 | 12 |
| B | | | | |
| Function | −1/4 | 15 | 0 | 12 |
| C | | | | |

In some embodiments, a look-up table may be used to determine the QP values. While in other embodiments, the relationship between QP offset and picture QP may be content dependent. For example, man-made objects such as houses and cars may work better with high QP differences even at high QPs, whereas natural objects may need a smaller QP difference at high QPs. In this example, it could first be determined whether the scene contains mostly natural objects. If so, a more aggressive QP offset mechanism could be used by selecting a first function or first look-up table that changes the QP offset greatly as a function of picture QP. If not, a less aggressive QP offset mechanism could be used by selecting a second function or second look-up table, one that would change the QP offset less as a function of picture QP.

### Certainty Threshold

In other embodiments, the analyzer 190, as shown in FIG. 1, provides a score c indicating how certain it is that the specified class of object can be found in the described position. This score c can be measured against a threshold T_{C}, indicating that the algorithm has a basic amount of certainty that the objects actually exist. The score may help avoid false positives, i.e., detecting objects that are not there, and coding the false positives with too many bits.

In some embodiments, the analyzer 190 may not produce or reveal the score, in this case all objects are assumed to have a certainty score c of 100%. In one embodiment, the threshold T_{C} is set to 70%, indicating that the algorithm treats all objects with a certainty score c of less than 70% as if they did not exist. In another embodiment, the threshold T_{C} consists of two thresholds, one for large objects T_{CL} and one for small objects T_{CS}. As large objects are generally easier to detect, T_{CL} can have a higher value than T_{CS}. For example, T_{CS} can be set to 40% and T_{CL} to 60.

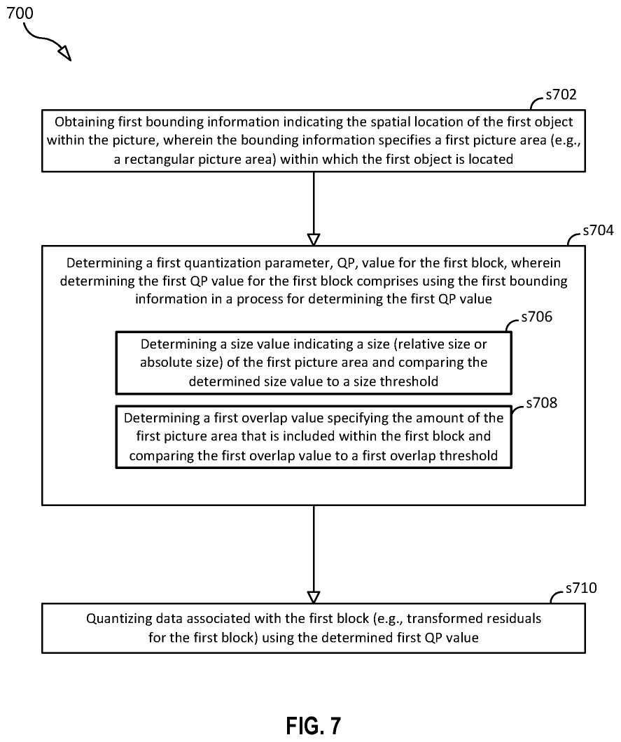

FIG. 7 is a flowchart illustrating a process 700 for encoding a picture in which at least a first object has been detected, wherein the picture comprises a first block. The first block may be embodied as a CTU. The picture may include any number of blocks of varying size and shape. In another embodiment, the block may be divided into smaller blocks, such as CUs, and the method is performed on each of the smaller blocks. Process 700 may begin in step s702.

Step s702 comprises obtaining first bounding information (e.g., a bounding box) indicating the spatial location of the first object within the picture, wherein the bounding information specifies a first picture area within which the first object is located. In one embodiment, the bounding information defines a bounding box. In other embodiments, the bounding information defines other shapes, such as ovals, circles or the shape of the first object. That is, the first picture area may be rectangular, circular, or any other shape and may be coextensive with the first object.

Steps s704 comprises determining a first QP value for the first block. Determining the first QP value for the first block comprises using the first bounding information in a process for determining the first QP value. The process for determining the first QP value comprises: i) determining a size value indicating a size (relative size or absolute size) of the first picture area and comparing the determined size value to a size threshold (steps s706) and/or ii) determining a first overlap value specifying the amount of the first picture area that is included within the first block and comparing the first overlap value to a first overlap threshold (step s708).

Steps s710 comprises quantizing data associated with the first block (e.g., transformed residuals for the first block) using the determined first QP value.

In some embodiments, the process for determining the first QP value may further include determining a second overlap value specifying the amount by which the first block is covered by the first picture area and comparing the second overlap value to a second overlap threshold. As a result of the second overlap value being greater than the second overlap threshold, the method may set the first QP value to a first value. In another embodiment, as a result of the second overlap value being less than the second overlap threshold, the method may set the first QP value to a second value. The second overlap threshold may be in the range of 5-30%, i.e., 5-30% of the block must be covered by the object's bounding. As part of Step s704, the method may comprise Step s706 and/or Step s708.

In some embodiments, process 700 may further comprise determining a certainty score, wherein the certainty score specifies a level of certainty that the first object exists in the picture. The process for determining the first QP value may comprise comparing the certainty score to a certainty threshold, wherein using the first bounding information in the process for determining the first QP value is performed if the certainty score exceeds the certainty threshold. In some embodiments, the method may not produce or reveal the score, in this case all objects are assumed to have a certainty score of 100%. In one embodiment, the certainty threshold is set to 70%, indicating that the algorithm treats all objects with a certainty score of less than 70% as if they did not exist. In another embodiment, the certainty threshold consists of two thresholds, one for large objects and one for small objects. As large objects are generally easier to detect, the large object certainty threshold can have a higher value than the small certainty threshold. In some embodiments process 700 further comprises obtaining a picture QP value. In such embodiments, determining the first QP value for the first block further comprises using the first bounding information and the picture QP value in the process for determining the first QP value. In another embodiment, using the first bounding information and the picture QP value comprises using the size value and/or first overlap value to select one or more parameters; and using the one or more parameter and the picture QP value to determine the first QP value.

In some embodiments, and using the one or more parameter and the picture QP value to determine the first QP value can, for example, be a linear function of the format:

$${QP}_{value} = m * {QP}_{picture} + n .$$

The resulting offset may additionally be clipped to a specified range:

$${QP}_{clip \_ offset} = Clip ( max , min , {QP}_{value} ) .$$

The clipping may adjust the QP value so that if the QP value exceeds the max value, the max value is used and, correspondingly, if the QP value is less than the min value, the min value is used. Otherwise, the QP value is not modified.

In some embodiments, the functions may be applied when using the one or more parameter and the picture QP value to determine the first QP value.

In some embodiments, a look-up table may be used to determine the first QP value. While in other embodiments, the relationship between first QP value and picture QP may be content dependent. For example, man-made objects such as houses and cars may work better with high QP differences even at high QPs, whereas natural objects may need a smaller QP difference at high QPs. In this example, it could first be determined whether the scene contains mostly natural objects. If so, a more aggressive first QP value mechanism could be used by selecting a first function or first look-up table that changes the first QP value greatly as a function of picture QP. If not, a less aggressive first QP value mechanism could be used by selecting a second function or second look-up table, one that would change the first QP value less as a function of picture QP.

In some embodiments, the method may comprise detecting a second object in the picture and obtaining second bounding information indicating the spatial location of the second object within the picture, wherein the bounding information specifies a second picture area within which the second object is located. In such an embodiment the process for determining the first QP value further comprises determining a second size value indicating a size of the second picture area and comparing the determined second size value to the size threshold.

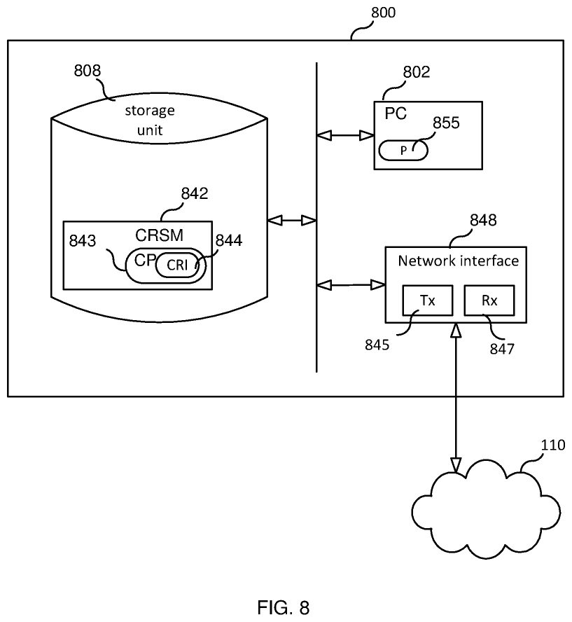

FIG. 8 is a block diagram of an encoder apparatus 800 for implementing encoder 102, according to some embodiments. As shown in FIG. 8, apparatus 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 800 may be a distributed computing apparatus); at least one network interface 848 (e.g., a physical interface or air interface) comprising a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling encoder apparatus 800 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes encoder apparatus 800 to perform steps described herein (e.g., steps described herein with reference to the flow charts). In other embodiments, encoder apparatus 800 may be configured to perform steps described herein without the need for code. That is, for example, PC 802 may consist merely of one or more ASICs. Hence, the features of the embodiments described herein may be implemented in hardware and/or software.

### Summary of Various Embodiments

A1. A method (700) for encoding a picture in which at least a first object has been detected, wherein the picture comprises a first block, the method comprising:
obtaining first bounding information indicating the spatial location of the first object within the picture, wherein the first bounding information specifies a first picture area (e.g., a rectangular picture area) within which the first object is located;
determining a first quantization parameter, QP, value for the first block, wherein determining the first QP value for the first block comprises using the first bounding information in a process for determining the first QP value, wherein the process for determining the first QP value comprises:
   determining a size value indicating a size (relative size or absolute size) of the first picture area and comparing the determined size value to a size threshold; and/or
   determining a first overlap value specifying the amount of the first picture area that is included within the first block and comparing the first overlap value to a first overlap threshold; and
quantizing data associated with the first block (e.g., transformed residual information for the first block) using the determined first QP value.

A2. The method of embodiment A1, wherein the process for determining the first QP value comprises:
determining the first overlap value;
comparing the first overlap value to the first overlap threshold; and
as a result of the first overlap value being greater than the first overlap threshold, setting the first QP value to a first value.

A3. The method of embodiment A1, wherein the process for determining the first QP value comprises:
determining a second overlap value specifying the amount by which the first block is covered by the first picture area; and
comparing the second overlap value to a second overlap threshold.

A4. The method of embodiment A3, wherein the process for determining the first QP value comprises:
as a result of the second overlap value being greater than the second overlap threshold, setting the first QP value to a first value.

A5. The method of embodiment A1, wherein the process for determining the first QP value comprises:
determining the size value;
comparing the determined size value to the size threshold;
determining a second overlap value specifying the amount by which the first block is covered by the first picture area;
comparing the second overlap value to a second overlap threshold; and
as a result of the size value of the first picture area being less than the size threshold and the first overlap value being greater than the second overlap threshold, setting the first QP value to a first value.

A6. The method of embodiment A1, further comprising:
detecting a second object in the picture; and
obtaining second bounding information indicating the spatial location of the second object within the picture, wherein the second bounding information specifies a second picture area within which the second object is located, wherein the process for determining the first QP value further comprises:
determining a second size value indicating a size of the second picture area and comparing the determined second size value to the size threshold; and/or
determining a third overlap value specifying the amount of the second picture area that is included within the first block and comparing the third overlap value to the first overlap threshold.

A7. The method of any one of embodiments A1-A6, wherein the size is a relative size or absolute size.

A8. The method of any one of embodiments A1-A7, further comprising:
determining a certainty score, wherein the certainty score specifies a level of certainty that the first object exists in the picture; wherein the process for determining the first QP value comprises:
comparing the certainty score to a certainty threshold, wherein
using the first bounding information in the process for determining the first QP value is performed if the certainty score exceeds the certainty threshold.

A9. The method of any one of embodiments A1-A8, further comprising:
obtaining a picture QP, wherein
determining the first QP value for the first block further comprises using the first bounding information and the picture QP in the process for determining the first QP value.

A10. The method of embodiment A9, wherein using the first bounding information and the picture QP comprises:
using the size value and/or first overlap value to select one or more parameters; and
using the one or more parameter and the picture QP to determine the first QP value.

B1. A computer program (843) comprising instructions (844) which when executed by processing circuitry (802) of an apparatus (800) causes the apparatus to perform the method of any one of the above embodiments.

B2. A carrier containing the computer program of embodiment D1, wherein the carrier is one of an electronic signal, an optical signal, a radio signal, and a computer readable storage medium (842).

C1. An encoder apparatus (800) for encoding a picture in which at least a first object has been detected, wherein the picture comprises a first block, the encoder apparatus being configured to perform a process comprising:
obtaining first bounding information indicating the spatial location of the first object within the picture, wherein the bounding information specifies a first picture area (e.g., a rectangular picture area) within which the first object is located;
determining a first quantization parameter, QP, value for the first block, wherein determining the first QP value for the first block comprises using the first bounding information in a process for determining the first QP value, wherein the process for determining the first QP value comprises:
   determining a size value indicating a size (relative size or absolute size) of the first picture area and comparing the determined size value to a size threshold; and/or
   determining a first overlap value specifying the amount of the first picture area that is included within the first block and comparing the first overlap value to a first overlap threshold; and
quantizing data associated with the first block (e.g., transformed residuals for the first block) using the determined first QP value.

C2. The encoder apparatus of embodiment C1, wherein the process for determining the first QP value comprises:
determining the first overlap value;
comparing the first overlap value to the first overlap threshold; and
as a result of the first overlap value being greater than the first overlap threshold, setting the first QP value to a first value.

C3. The encoder apparatus of embodiment C1, wherein the process for determining the first QP value comprises:
determining a second overlap value specifying the amount by which the first block is covered by the first picture area; and
comparing the second overlap value to a second overlap threshold.

C4. The encoder apparatus of embodiment C3, wherein the process for determining the first QP value comprises:
as a result of the second overlap value being greater than the second overlap threshold, setting the first QP value to a first value.

C5. The encoder apparatus of embodiment C1, wherein the process for determining the first QP value comprises:
determining the size value;
comparing the determined size value to the size threshold;
determining a second overlap value specifying the amount by which the first block is covered by the first picture area;
comparing the second overlap value to a second overlap threshold; and
as a result of the size value of the first picture area being less than the size threshold and the first overlap value being greater than the second overlap threshold, setting the first QP value to a first value.

C6. The encoder apparatus of embodiment C1, wherein the process further comprises:
detecting a second object in the picture; and
obtaining second bounding information indicating the spatial location of the second object within the picture, wherein the second bounding information specifies a second picture area within which the second object is located, wherein the process for determining the first QP value further comprises:
determining a second size value indicating a size of the second picture area and comparing the determined second size value to the size threshold; and/or
determining a third overlap value specifying the amount of the second picture area that is included within the first block and comparing the third overlap value to the first overlap threshold.

C7. The encoder apparatus of any one of embodiments C1-C6, wherein the size is a relative size or absolute size.

C8. The encoder apparatus of any one of embodiments C1-C7, the encoder apparatus is further operable to:
determine a certainty score, wherein the certainty score specifies a level of certainty that the first object exists in the picture, wherein
the process for determining the first QP value comprises comparing the certainty score to a certainty threshold, and
using the first bounding information in the process for determining the first QP value is performed if the certainty score exceeds the certainty threshold.

C9. The encoder apparatus of any one of embodiments C1-C8, wherein the encoder apparatus is further operable to:
obtain a picture QP, wherein
determining the first QP value for the first block further comprises using the first bounding information and the picture QP in the process for determining the first QP value.

C10. The encoder apparatus of embodiment C9, wherein using the first bounding information and the picture QP comprises:
using the size value and/or first overlap value to select one or more parameters; and
using the one or more parameter and the picture QP to determine the first QP value.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for encoding a picture in which at least a first object has been detected, wherein the picture comprises a first block, the method comprising:
obtaining first bounding information indicating the spatial location of the first object within the picture, wherein the first bounding information specifies a first picture area within which the first object is located;
determining a first quantization parameter (QP) value for the first block, wherein determining the first QP value for the first block comprises using the first bounding information in a process for determining the first QP value, wherein the process for determining the first QP value comprises:
determining a size value indicating a size of the first picture area and comparing the determined size value to a size threshold; and/or
determining a first overlap value specifying the amount of the first picture area that is included within the first block and comparing the first overlap value to a first overlap threshold; and
quantizing data associated with the first block using the determined first QP value.

2. The method of claim 1, wherein the process for determining the first QP value comprises:
determining the first overlap value;
comparing the first overlap value to the first overlap threshold; and
as a result of the first overlap value being greater than the first overlap threshold, setting the first QP value to a first value.

3. The method of claim 1, wherein the process for determining the first QP value comprises:
determining a second overlap value specifying the amount by which the first block is covered by the first picture area; and
comparing the second overlap value to a second overlap threshold.

4. The method of claim 3, wherein the process of determining the first QP value comprises:
as a result of the second overlap value being greater than the second overlap threshold, setting the first QP value to a first value.

5. The method of claim 1, wherein the process for determining the first QP value comprises:
determining the size value;
comparing the determined size value to the size threshold;
determining a second overlap value specifying the amount by which the first block is covered by the first picture area;
comparing the second overlap value to a second overlap threshold; and
as a result of the size value of the first picture area being less than the size threshold and the first overlap value being greater than the second overlap threshold, setting the first QP value to a first value.

6. The method of claim 1, further comprising:
detecting a second object in the picture; and
obtaining second bounding information indicating the spatial location of the second object within the picture, wherein
the second bounding information specifies a second picture area within which the second object is located, and
the process for determining the first QP value further comprises:
determining a second size value indicating a size of the second picture area and comparing the determined second size value to the size threshold; and/or
determining a third overlap value specifying the amount of the second picture area that is included within the first block and comparing the third overlap value to the first overlap threshold.

7. The method of claim 1, wherein the size is a relative size or absolute size.

8. The method of claim 1, further comprising:
determining a certainty score, wherein the certainty score specifies a level of certainty that the first object exists in the picture; wherein the process for determining the first QP value comprises:
comparing the certainty score to a certainty threshold, wherein
using the first bounding information in the process for determining the first QP value is performed if the certainty score exceeds the certainty threshold.

9. The method of claim 1, further comprising:
obtaining a picture QP, wherein
determining the first QP value for the first block further comprises using the first bounding information and the picture QP in the process for determining the first QP value.

10. The method of claim 9, wherein using the first bounding information and the picture QP comprises:
using the size value and/or first overlap value to select one or more parameters; and
using the one or more parameter and the picture QP to determine the first QP value.

11. A non-transitory computer readable storing medium storing a computer program comprising instructions which when executed by processing circuitry of an apparatus causes the apparatus to perform the method of claim 1.

12. (canceled)

13. An encoder apparatus for encoding a picture in which at least a first object has been detected, wherein the picture comprises a first block, the encoder apparatus comprising:
memory; and
processing circuitry, wherein the encoder apparatus is configured to perform a method comprising:
obtaining first bounding information indicating the spatial location of the first object within the picture, wherein the first bounding information specifies a first picture area within which the first object is located;
determining a first quantization parameter (QP) value for the first block, wherein determining the first QP value for the first block comprises using the first bounding information in a process for determining the first QP value, wherein the process for determining the first QP value comprises:
determining a size value indicating a size of the first picture area and comparing the determined size value to a size threshold; and/or
determining a first overlap value specifying the amount of the first picture area that is included within the first block and comparing the first overlap value to a first overlap threshold; and
quantizing data associated with the first block using the determined first QP value.

14. The encoding apparatus of claim 13, wherein the process for determining the first QP value comprises:
determining the first overlap value;
comparing the first overlap value to the first overlap threshold; and
as a result of the first overlap value being greater than the first overlap threshold, setting the first QP value to a first value.

15. The encoding apparatus of claim 13, wherein the process for determining the first QP value comprises:
determining a second overlap value specifying the amount by which the first block is covered by the first picture area; and
comparing the second overlap value to a second overlap threshold.

16. The encoding apparatus of claim 15, wherein the process of determining the first QP value comprises:
as a result of the second overlap value being greater than the second overlap threshold, setting the first QP value to a first value.

17. The encoding apparatus of claim 13, wherein the process for determining the first QP value comprises:
determining the size value;
comparing the determined size value to the size threshold;
determining a second overlap value specifying the amount by which the first block is covered by the first picture area;
comparing the second overlap value to a second overlap threshold; and
as a result of the size value of the first picture area being less than the size threshold and the first overlap value being greater than the second overlap threshold, setting the first QP value to a first value.

18. The encoding apparatus of claim 13, wherein the method further comprises:
detecting a second object in the picture; and
obtaining second bounding information indicating the spatial location of the second object within the picture, wherein
the second bounding information specifies a second picture area within which the second object is located, and
the process for determining the first QP value further comprises:
determining a second size value indicating a size of the second picture area and comparing the determined second size value to the size threshold; and/or
determining a third overlap value specifying the amount of the second picture area that is included within the first block and comparing the third overlap value to the first overlap threshold.

19. The encoding apparatus of claim 13, wherein the size is a relative size or absolute size.

20. The encoding apparatus of claim 13, wherein the method further comprises:
determining a certainty score, wherein the certainty score specifies a level of certainty that the first object exists in the picture; wherein the process for determining the first QP value comprises:
comparing the certainty score to a certainty threshold, wherein
using the first bounding information in the process for determining the first QP value is performed if the certainty score exceeds the certainty threshold.

21. The encoding apparatus of claim 13, wherein the method further comprises:
obtaining a picture QP, wherein
determining the first QP value for the first block further comprises using the first bounding information and the picture QP in the process for determining the first QP value.
